(19) United States
(12) Patent Application Publication
(10) Pub. No.: US 2014/0320352 A1
(43) Pub. Date: Oct. 30, 2014

(54) TOUCH PANEL MODULE AND TOUCH DISPLAY PANEL WITH ANTENNA STRUCTURE

(71) Applicant: WINTEK CORPORATION, Taichung City (TW)

(72) Inventors: Chen-Ho Hsu, Kaohsiung City (TW); Ching-Fu Hsu, Taichung City (TW); Yu-Hua Wu, Taoyuan County (TW); Chang-Hsuan Hsu, Changhua County (TW); Chong-Wei Li, Changhua County (TW)

(73) Assignee: WINTEK CORPORATION, Taichung City (TW)

(21) Appl. No.: 14/259,160

(22) Filed: Apr. 23, 2014

(30) Foreign Application Priority Data
Apr. 26, 2013 (TW) 102115058

(51) Int. Cl. H01Q 1/24

(52) U.S. Cl. CPC H01Q 1/24
USPC 343/702

(57) ABSTRACT

A touch panel module with antenna structure includes a touch panel, a structure layer and an antenna coil. The structure layer includes a first surface and a second surface that are opposite to each other, and the first surface of the structure layer faces the touch panel. The antenna coil is disposed on the first surface of the structure layer.

### BACKGROUND OF THE INVENTION

1. Field of the Invention

The invention relates to a touch panel module and a touch display panel with antenna structure, and more particularly, to a touch panel module and a touch display panel with an antenna structure formed on a structure layer.

2. Description of the Prior Art

Near field communication (hereinafter abbreviated as NFC) is a contactless-type short-range wireless communication technique. NFC allows wireless communication between devices in a frequency band of 13.56 Megahertz (MHz). NFC includes multiple operating modes such as card emulation mode, point-to-point mode, and reader/writer mode. Briefly speaking, applications of the card emulation mode for NFC-enabled devices include electronic tickets, electronic wallet or credit cards. In the point-to-point mode, data exchange is allowed between two working NFC-enabled terminal devices. In the reader/writer mode, the NFC-enabled device reads information of specific specification, such as product information. Because of the convenience, the NFC-enabled devices are becoming more popular in the marketplace. For example, more and more portable electronic devices (PED) are equipped with NFC technique for realizing contactless communication and providing more convenient e-commerce service.

Conventionally, the NFC technique includes a NFC circuit, an antenna matching circuit, and an antenna coil. It is found difficult and complicated to integrate the three aforementioned elements to portable electronic devices. For example, to integrate the NFC circuit and the antenna matching circuit, the original circuit design must be modified. Consequently, design complexity is increased. Furthermore, for disposing the antenna coil, which occupies large area of the circuit board, not only the original circuit layout design is changed, but also the valuable space on the circuit board may not enough. Additionally, since the resistance requirement of the antenna must be met, the thickness of the antenna coil is always in consideration. And thus controllability for the thickness of the antenna coil and complexity of the circuit fabrication process issues are both considered.

### SUMMARY OF THE INVENTION

In accordance with the foregoing discussion, it is therefore an objective of the present invention to provide a touch panel module and a touch display panel with an antenna structure formed on a structure layer. Because the antenna structure is disposed on the structure layer that is then attached to the touch panel module or the touch display panel, modification to the original circuit design for accommodating the antenna structure is no longer required. Furthermore, the fabrication process for the touch panel module or the touch display panel is consequently simplified. Additionally, since the antenna structure is disposed on the structure layer, controllability for film thickness of the antenna structure is improved and thus the process yield is increased.

According to a preferred embodiment of the present invention, a touch panel module with antenna structure is provided. The touch panel module includes a touch panel, a structure layer, and an antenna coil. The structure layer includes a first surface and a second surface, and the first surface and the second surface are opposite to each other. The first surface faces the touch panel. The antenna coil is disposed on the first surface of the structure layer.

According to another preferred embodiment of the present invention, a touch display panel with antenna structure is provided. The touch display panel with antenna structure includes a touch panel module and a display panel. The touch panel module includes a touch panel, a structure layer, and an antenna coil. The structure layer includes a first surface and a second surface, and the first surface and the second surface are opposite to each other. The first surface of the structure layer faces the touch panel and the second surface of the structure layer faces the display panel. The antenna coil is disposed on the first surface of the structure layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic drawings illustrating a method for manufacturing an antenna structure according to a preferred embodiment provided by the present invention.

FIG. 4 is a schematic drawing illustrating an antenna structure provided by a preferred embodiment of the present invention.

FIG. 5 is a schematic drawing illustrating a modification to the antenna structure provided by the preferred embodiment.

FIG. 6 is a schematic drawing illustrating a touch panel module with antenna structure provided by a preferred embodiment of the present invention.

FIG. 7 is a schematic drawing illustrating a modification to the touch panel module with antenna structure provided by the preferred embodiment.

FIG. 8 is a schematic drawing illustrating a touch display panel with antenna structure provided by a preferred embodiment of the present invention.

### DETAILED DESCRIPTION

A more complete understanding of the present invention will be afforded to those skilled in the art, as well as a realization of additional advantages and objects thereof, by a consideration of the following detailed description of the preferred embodiment.

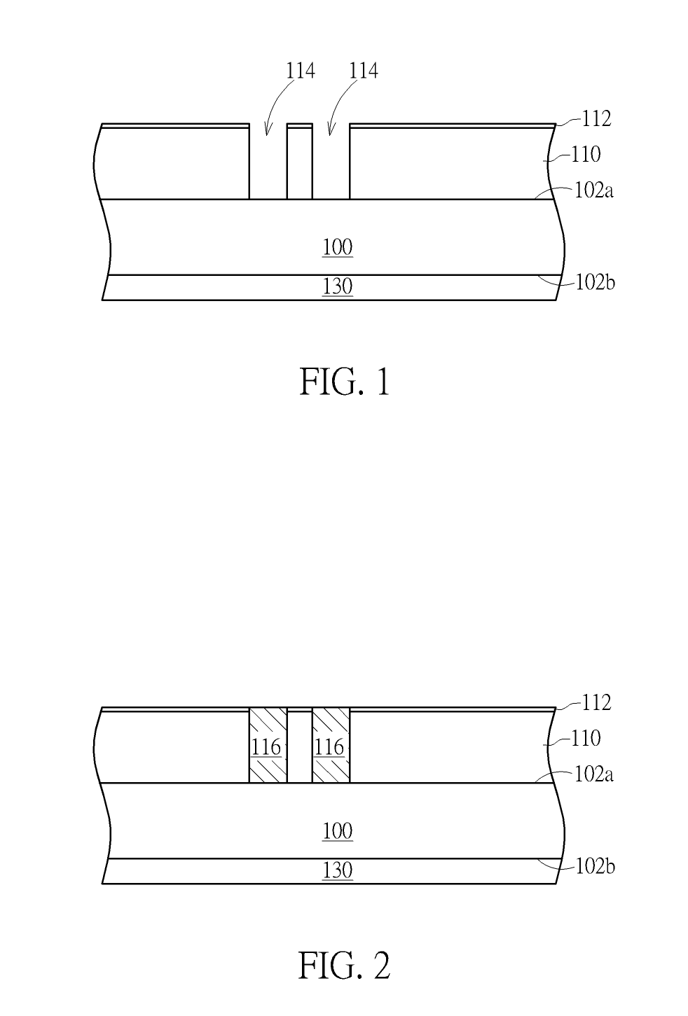

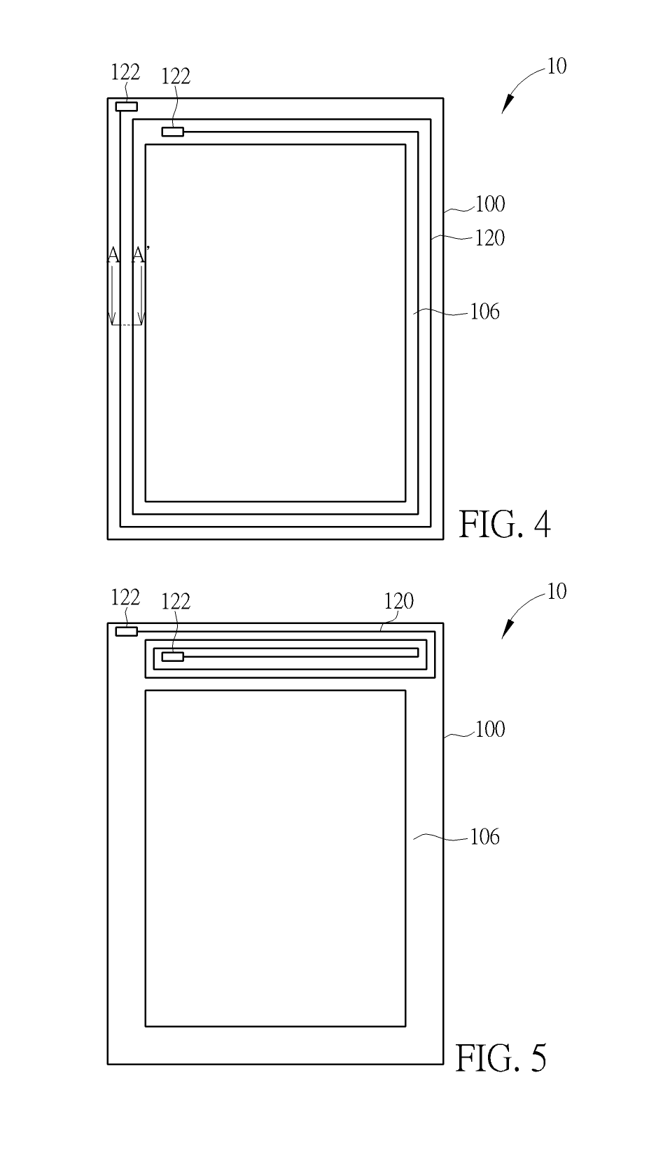

Please refer to FIGS. 1-4, which are schematic drawings illustrating a method for manufacturing an antenna structure according to the preferred embodiment provided by the present invention. It should be noted that FIG. 3 is a cross-sectional view taken along a Line A-A′ of FIG. 4. It is noted that the drawings are provided for illustrative purposes, and as such, they are not to drawn to scale and modification can be made if required. As shown in FIG. 1, in the preferred embodiment, a structure layer 100 is provided by the method for manufacturing the antenna structure in advance. In the preferred embodiment, the structure layer 100 exemplarily is an anti-scattering film (ASF), but not limited thereto. The structure layer 100 includes a first surface 102a and a second surface 102b, and the first surface 102a and the second surface 102b are opposite to each other. The structure layer 100 can be made from polymethylmethacrylate (PMMA), triacetyl cellulose, polyethylene terephthalate (PET), polypropylene (PP), or the combination thereof. However, those skilled in the art would easily realize that since the structure layer 100 can be films other than anti-scattering film (ASF), the structure layer 100 can include material other than those mentioned above. Furthermore, a shielding layer 130, such as a transparent conductive layer, can be disposed on the second surface 102b of the structure layer 100. The transparent conductive layer can include indium tin oxide (ITO), indium zinc oxide (IZO), aluminum zinc oxide (AZO), zinc oxide (ZnO), or tin oxide, but not limited to this. Additionally, the shielding layer 130 may be formed a metal mesh pattern with plural metal lines each having the line width from 0.1 um to 10 um.

Please still refer to FIG. 1. Next, an insulating layer 110 and a release layer 112 are sequentially formed on the first surface 102a of the structure layer 100. In the preferred embodiment, the insulating layer 110 is an adhesive layer. However, the insulating layer 110 can be a non-conductive layer without adhesivity in a modification to the preferred embodiment. Subsequently, a patterning process, such as a Laser cutting process, is performed to pattern the insulating layer 110 and the release layer 112. Accordingly, an insulating pattern with a groove 114 having a coil pattern (shown in FIG. 4) is formed in the insulating layer 110 and release layer 112.

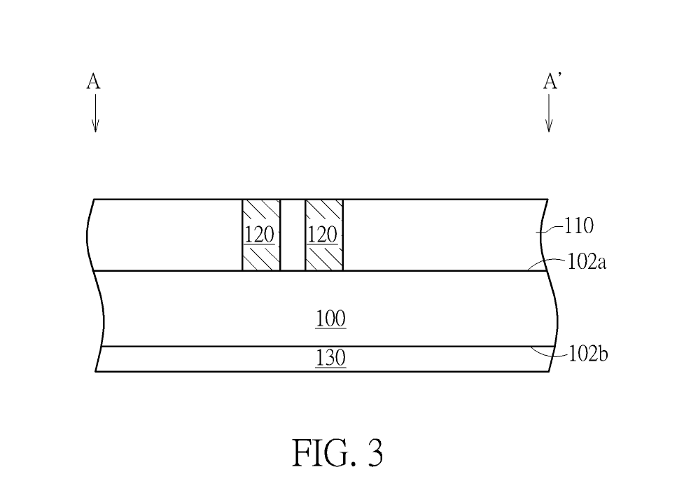

Please refer to FIG. 2. After forming the groove 114, a conductive material 116 is provided to fill up the groove 114. The conductive material 116 can include metal conductive material or transparent conductive material. In the preferred embodiment, the conductive material 116 is a metal conductive material such as a conductive paste. The conductive paste is dispensed into the groove 114, and subsequently the superfluous conductive paste is removed from the release layer 112.

Please refer to FIG. 3. After filling up the groove 114 with the conductive material 116, the release layer 112 is removed. Since the conductive material 116 involved in the preferred embodiment is a conductive paste, a thermal treatment is performed to bake the conductive paste. Consequently, an antenna coil 120 is embedded in the groove 114, and thus an antenna structure 10 is obtained according to the preferred embodiment.

Accordingly, it is observed that a thickness of the antenna coil 120 is decided by a thickness of the insulating layer 110, a thickness of the release layer 112, a viscosity and solid content (that is the ratio between the conductive material left after baking and the original conductive material of the conductive material 116 before baking). Since the four parameters can be easily controlled during the fabrication process, the thickness of the antenna coil 120 is ensured to be between 20 Angstroms (Å) and 500 Å according to the preferred embodiment. And therefore, the resistance of the antenna coil 120 is ensured to be lower than 10 Ohms (Ω).

Please still refer to FIG. 4, which is a schematic drawing illustrating an antenna structure a preferred embodiment of the present invention. It is should be noted that the antenna structure provided by the preferred embodiment can be made by the method mentioned above, therefore a cross-sectional view taken along a Line A-A′ of FIG. 4 can be identical to FIG. 3. Accordingly, in order to clearly describe the structure of the present invention, FIG. 3 and FIG. 4 should be referred together. Since the antenna structure 10 provided by the invention can be integrated with a touch panel module and a touch display panel, a peripheral region 106, which is corresponding to a peripheral region of a touch panel module or a touch display panel, is defined on the structure layer 100. More important, the antenna coil 120 is disposed in the peripheral region 106 and thus surrounds the touch panel module or the touch display panel as shown in FIGS. 3-4. Furthermore, a terminal pad 122 is disposed respectively at two terminals of the antenna coil 120 as shown in FIG. 4. According to the preferred embodiment, the antenna coil 120 serves as an NFC antenna, but not limited to this. Those skilled in the art would easily realize that the antenna coil 120 can serve as an antenna coil required by other contactless RFID devices.

Please refer to FIG. 5, which is a schematic drawing illustrating a modification to the antenna structure 10 provided by the preferred embodiment. Different from the above-mentioned preferred embodiment, of which the antenna coil 120 disposed in the peripheral region 106 surrounds the touch panel module or the touch display panel, the modification provides an antenna coil 120 individually disposed on one side of the peripheral region 106 according on different product requirement.

Briefly, the antenna structure 10 provided by the preferred embodiment can be easily integrated to all categories of anti-scattering film in state-of-the-art or other function films. Since the antenna structure is no longer disposed in the circuit board or the panel, the fabrication processes are simplified and costs are reduced. Furthermore, since the antenna structure 10 provided by the preferred embodiment can be easily formed in the peripheral region 106, which is corresponding to the peripheral region of the touch panel or the touch display panel, practicability of the antenna structure 10 is improved. More important, the thickness of the antenna coil 120 and the resistance of the antenna structure 10 are easily controlled to be lower than 10 Ohms (Ω) according to the manufacturing method provided by the preferred embodiment. Preferably, the antenna coil 120 may be made from the paste with metal material such as gold, silver, copper, or the like.

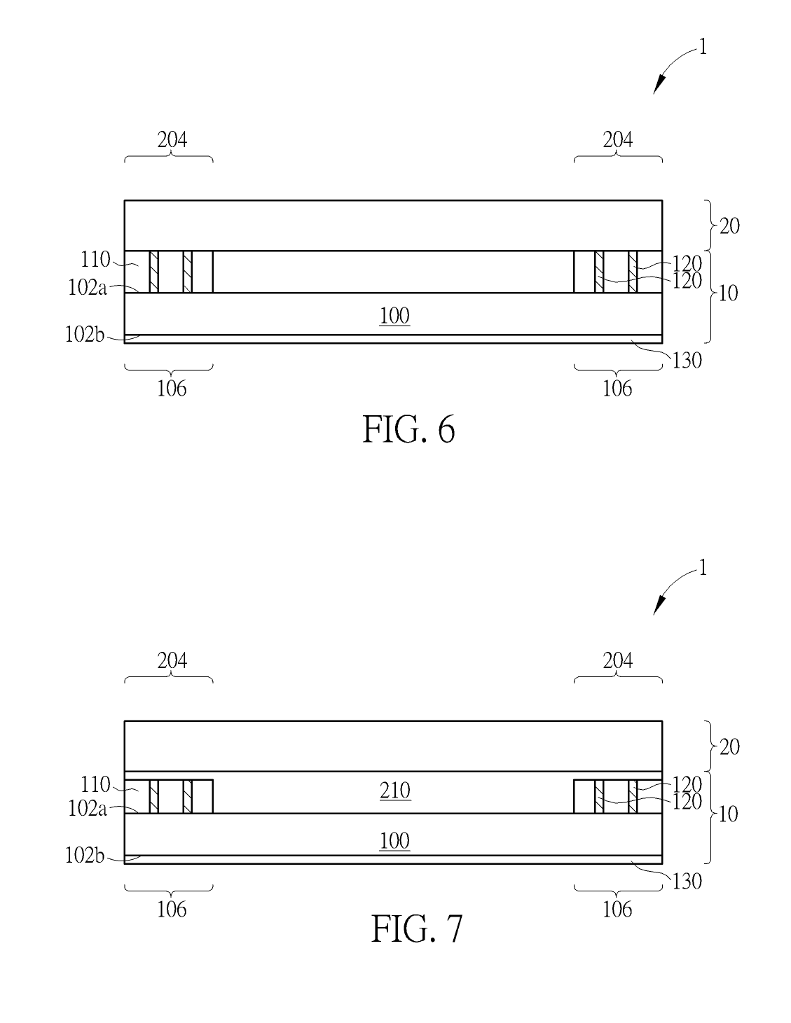

Please refer to FIGS. 6-7, wherein FIG. 6 is a schematic drawing illustrating a touch panel module having antenna structure provided by a preferred embodiment of the present invention, and FIG. 7 is a schematic drawing illustrating a modification to the touch panel module having antenna structure provided by the preferred embodiment.

Please refer to FIGS. 6 and 7 together. According to the preferred embodiment and the modification, a touch panel 20 is provided. The touch panel 20 includes a peripheral region 204 defined thereon, and at least a signal circuit and a black matrix (both not shown) are disposed in the peripheral region 204. More specific, the peripheral region 106 of the structure layer 100 corresponds to the peripheral region 204 of the touch panel 20. However, since details of the touch panel 20 are well-known to those skilled in the art, those details are omitted herein in the interest of brevity.

Please refer to FIGS. 6 and 7 again. As mentioned above, the antenna coil 120 of the antenna structure 10 is disposed on the structure layer 100, which is attached to the touch panel 20. Accordingly, when the insulating layer 110 of the antenna structure 10 includes an adhesive layer such as a double-sided adhesive, the structure layer 100 and the antenna structure 10 are directly attached to the touch panel 20 by the adhesive layer. Thereby a touch panel module 1 with the antenna structure 10 is constructed as shown in FIG. 6. Alternatively, when the insulating layer 110 of the antenna structure 10 contains no adhesivity, another adhesive layer 210 is provided. The adhesive layer 210 includes a liquid optically clear adhesive (LOCA) or a pressure sensitive adhesive (PSA), but not limited thereto. The adhesive layer 210 is formed on the first surface 102a of the structure layer 100, a surface of the insulating layer 110, and a surface of the antenna coil 120. Thereby the antenna structure 10 is attached to the touch panel 20 as shown in FIG. 7.

It is noteworthy that the antenna coil 120 of the antenna structure 10 is disposed on the first surface 102a of structure layer 100 correspondingly to the peripheral region 204 of the touch panel 20 according to the preferred embodiment and the modification. In another modification to the preferred embodiment, a shielding layer 130 can be disposed on the second surface 102b of the structure layer 100 for protecting the touch panel 20 from external interference such as signals from LCD module.

According to the touch panel module 1 provided by the preferred embodiment and its modification, the antenna coil 120, which consumes precious space, is disposed on the structure layer 100 independently from the touch panel 20. The antenna structure 10 is attached to the touch panel 20 by the insulating layer 110 having adhesivity or by another adhesive layer 210/212. Consequently, the touch panel 20 obtains the NFC function without modifying original circuit design of the touch panel and fabrication process for the touch panel. Additionally, since the structure layer 100 of the antenna structure 10 can be an anti-scattering film, it efficaciously prevents the patterned sensing electrode layer of the touch panel 20 from scatting upon impacts. Furthermore, a shielding layer 130 can be disposed on the second surface 102b or the first surface 102a of the structure layer 100 if required, and thereby interference is further shielded.

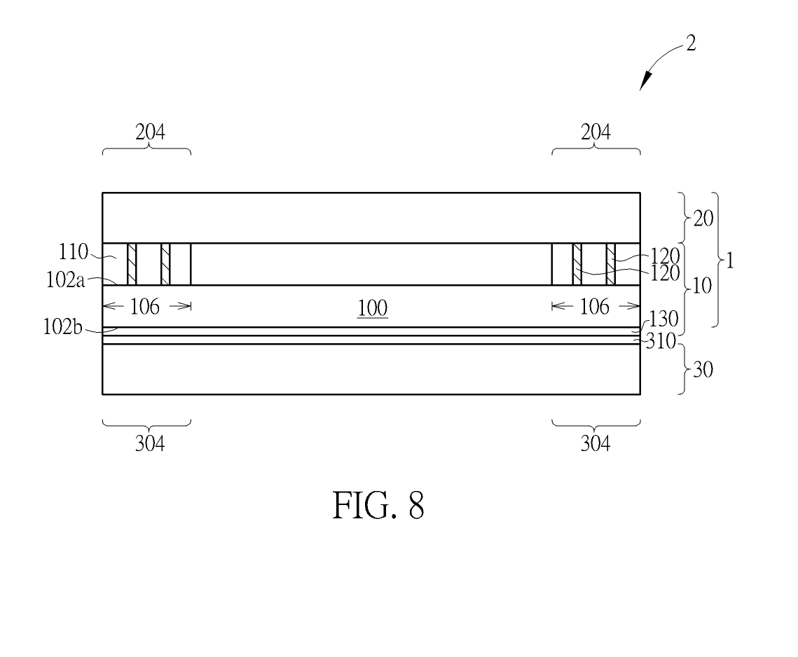

Please refer to FIG. 8, which is a schematic drawing illustrating a touch display panel having the antenna structure provided by a preferred embodiment of the present invention. As shown in FIG. 8, a touch display panel 2 is provided. The touch display panel 2 is an out-cell touch panel in the preferred embodiment. Accordingly, the touch display panel 2 includes an antenna structure 10 as mentioned above, a touch panel 20 as mentioned above, and a display panel 30. The display panel 30 preferably includes a liquid crystal display (LCD) panel, an organic light emitting diode (OLED) display panel, an electro-wetting display panel, an e-ink display panel, a plasma display panel, or a field emitting display (FED) panel, but not limited thereto. In the preferred embodiment, the display panel 30 is exemplarily an LCD panel, but not limited thereto. The display panel 30 includes a peripheral region 304, and driving circuits for driving pixels are disposed in the peripheral region 304. As shown in FIG. 8, the antenna structure 10 is disposed in between the touch panel 20 and the display panel 30. More specific, the peripheral region 106 of the structure layer 100 corresponds to the peripheral region 204 of the touch panel 20 and the peripheral region 304 of the display panel 30.

As mentioned above, the antenna structure 10 includes the structure layer 100, the insulating layer 110 disposed on the first surface 102a of the structure layer 100, and the antenna coil 120 disposed in the insulating layer 110. According to the preferred embodiment and its modification, the first surface 102a of the structure layer 100 faces the touch panel 20, and the second surface 102b faces the display panel 30. Therefore, the antenna coil 120 disposed on the first surface 102a is near the touch panel 20. When the insulating layer 110 includes an adhesive material, the antenna structure 10 is directly attached to the touch panel 20 as shown in FIG. 8. When the insulating layer 110 includes non-adhesive material, another adhesive layer 210 (as shown in FIG. 7) is formed on the surface of the antenna structure 10 and thereby the antenna structure 10 is attached to the touch panel 20. In the preferred embodiment, another adhesive layer 310 is provided on the second surface 102b of the structure layer 100 of the antenna structure 10. And the antenna structure 10 and the display panel 30 are attached by the adhesive layer 310. Furthermore, the antenna coil 120 is disposed correspondingly to the peripheral region 304 of the display panel 30 as shown in FIG. 8. Additionally, a shielding layer 130 is disposed on the first surface 102a or the second surface 102b of the structure layer 100 for shielding signals and preventing the touch panel 20 and the display panel 30 from interfering each other according to the preferred embodiment and its the modification.

According to the touch display panel 2 provided by the preferred embodiment and its modification, the antenna coil 120, which consumes precious space, is disposed on the structure layer 100. Consequently, the touch display panel 2 obtains the NFC function without modifying original circuit design of the touch panel and fabrication process for the touch panel. Furthermore, since the touch panel 20 is an out-cell touch panel, the touch panel 20 and the antenna structure 10 (that construct the touch panel module 1 as mentioned above) can be attached to the display panel 30 by the adhesive layer 310. Accordingly, it is conceivable that touch panel module 1 can be easily integrated into all categories of display panel in state-of-the-art. And thus practicability is improved. Additionally, since the structure layer 100 of the antenna structure 10 can be an anti-scattering film, it efficaciously prevents the patterned sensing electrode layer from scatting upon an impact. Furthermore, a shielding layer 130 can be disposed on the second surface 102b or the first surface 102a of the structure layer 100 if required. Thereby interference is further shielded.

Accordingly, a touch panel module and a touch display panel with an antenna structure formed on a structure layer are provided. Because the antenna structure is disposed on the structure layer that is then attached to the touch panel module or the touch display panel, modification to the original circuit design for accommodating the antenna structure is no longer required. And the fabrication process for the touch panel module or the touch display panel is consequently simplified. Furthermore, the antenna structure can be easily integrated to all categories of touch panel and display panel. Additionally, since the antenna structure is disposed on the structure layer, controllability for film thickness of the antenna structure is improved and thus the process yield is increased. More important, the antenna structure provided by the present invention possesses superior practicability because it holds not only the NFC function, but also the anti-scatting function and the shielding function.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel module with antenna structure comprising:
a touch panel;
a structure layer having a first surface and a second surface opposite to the first surface, and the first surface facing the touch panel; and
an antenna coil disposed on the first surface of the structure layer.

2. The touch panel module with antenna structure according to claim 1, wherein the structure layer is an anti-scattering film (ASF).

3. The touch panel module with antenna structure according to claim 1, wherein the touch panel comprises a peripheral region, and the antenna coil is disposed correspondingly to the peripheral region.

4. The touch panel module with antenna structure according to claim 1, further comprising a shielding layer disposed on the second surface of the structure layer.

5. The touch panel module with antenna structure according to claim 1, further comprising an insulating pattern disposed on the first surface of the structure layer, wherein the insulating pattern comprises a groove and the antenna coil is formed in the groove.

6. The touch panel module with antenna structure according to claim 5, wherein the insulating pattern comprises a double-sided adhesive for attaching the structure layer to the touch panel.

7. The touch panel module with antenna structure according to claim 1, wherein the resistance of the antenna coil is lower than 10 Ohms (Ω).

8. A touch display panel with antenna structure comprising:
a touch panel module comprising:
a touch panel;
a structure layer having a first surface and a second surface opposite to the first surface, and the first surface facing to the touch panel; and
an antenna coil disposed on the first surface of the structure layer; and
a display panel facing the second surface of the structure layer.

9. The touch display panel with antenna structure according to claim 8, wherein the structure layer is an anti-scattering film.

10. The touch display panel with antenna structure according to claim 8, wherein the touch panel comprises a peripheral region, and the antenna coil is disposed correspondingly to the peripheral region.

11. The touch display panel with antenna structure according to claim 8, further comprising a shielding layer disposed on the second surface of the structure layer.

12. The touch display panel with antenna structure according to claim 8, wherein the touch panel module further comprises an insulating pattern, the insulating pattern comprises a groove, and the antenna coil is formed in the groove.

13. The touch display panel with antenna structure according to claim 12, wherein the insulating pattern comprises a double-sided adhesive for assembling the touch panel and the structure layer.

14. The touch panel module with antenna structure according to claim 8, wherein the resistance of the antenna coil is lower than 10 Ohms (Ω).
